(19) United States
(12) Patent Application Publication
(10) Pub. No.: US 2023/0245009 A1
(43) Pub. Date: Aug. 3, 2023

(54) CARBON FOOTPRINT REMEDIATION

(71) Applicant: Hewlett-Packard Development Company, L.P., Spring, TX (US)

(72) Inventors: Gaurav Roy, Spring, TX (US); Prateek Tiwari, Pune (IN); Adnan Mirza, Spring, TX (US)

(73) Assignee: Hewlett-Packard Development Company, L.P., Spring, TX (US)

(21) Appl. No.: 18/000,326

(22) PCT Filed: Jun. 17, 2021
(86) PCT No.: PCT/US2021/037918

§ 371 Date: Nov. 30, 2022

(30) Foreign Application Priority Data
Jun. 17, 2020 (IN) 202041025515

(51) Int. Cl. G06Q 10/0631

(52) U.S. Cl. CPC G06Q 10/0631

(57) ABSTRACT

In an example implementation according to aspects of the present disclosure, a system, method, and storage medium for carbon footprint remediation. A processor receives a set of utilization data from computing devices. The processor determines a location data corresponding to utilization data of the one of the computing devices. The processor determines a carbon footprint of the computing devices based on the utilization data and the location data. The processor compares the carbon footprint against a carbon footprint threshold. The processor transmits remediation control instructions, based on the comparison, to the computing devices

### BACKGROUND

Computer systems utilize electricity for operation. Large corporations and computer fleet managers manage multiple computer systems across many physical sites.

### BRIEF DESCRIPTION OF THE DRAWINGS

FIG. 1 illustrates a carbon footprint remediation system, according to an example;

FIG. 2 is a block diagram corresponding to a method of determining a carbon footprint remediation, according to an example;

FIG. 3 is an illustration of site determination for carbon footprint remediation according to an example; and

FIG. 4 is a computing device for supporting instructions for carbon footprint remediation, according to an example.

### DETAILED DESCRIPTION

Within an organization, a company for example, many computing devices may be utilized to facilitate operation. For large organizations, the operation may include multiple physical sites in various locations throughout the world. Unique to each location may be the source of electricity to operate the computing devices and the carbon dioxide impact created in the generation of the electricity. In operation, the computing devices may create a determinable carbon footprint. As described herein, are systems, methods, and machine-readable mediums for carbon footprint remediation.

Within an organization, often computing devices may include but are not limited to desktop computers, laptop computers, printers, three dimensional (3D) printers, network switches, and wireless access points (WAPs). The computing devices may be configurable and operable to execute instructions to change how the device behaves. For example, a laptop computer may operate in a reduced power or power conservation mode when mobile and operating on battery power. The reduced power mode may include lowering the screen brightness, turning off unused network adapters, and throttling the central processing unit (CPU) clock speed. Other power conservation modes may include limited CPU utilization. For example, a system configuration may limit computationally expensive applications from executing.

An organization may have multiple sites in multiple countries. Each country may have different power sources utilizing carbon releasing fuels. For example, the same amount of consumed electricity in Germany may release less carbon than the same amount of consumed electricity in Estonia. Using this example, a company using the same model computing device running the same applications in the same power mode would have a higher carbon footprint in Estonia.

In one example, a system may include a plurality of computing devices. The plurality of computing devices may be connected to a processor. The processor may receive a set of utilization data from the plurality of computing devices. The processor may determine a set of location data wherein each of location data in the set of location data corresponds to one of the set of utilization data of the plurality of computing devices. The processor may determine a carbon footprint of the plurality of computing devices based on the set of utilization data and the set of location data. The processor may compare the carbon footprint against a carbon footprint threshold. The processor may then transmit remediation control instructions, based on the comparison, to the plurality of computing devices.

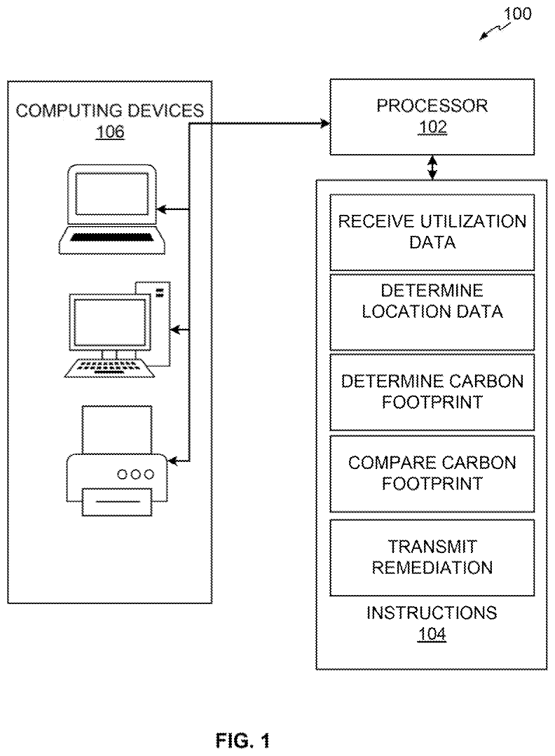

FIG. 1 illustrates a carbon footprint remediation system 100, according to an example. The system may include a processor 102, instructions 104 for the processor 102, and a plurality of computing devices 106.

The processor 102 may be implemented as a general-purpose processor such as a central processing unit (CPU). The processor 102 may also be implemented as a virtual processor. A virtual processor may be abstracted from a specific piece of hardware and may be defined by the workload it processes. A virtual processor may be a cloud processing instance, or a virtual machine instance. The processor 102 may be connected to supporting electronics including a host system and a network (not shown) to facilitate the operation of the processor.

The processor 102 may be able to process instructions 104. The instructions 104 may be firmware or software to change or control the behavior of the processor 102. For example, instructions 104 for the processor may including receiving utilization data, determining location data, determining a carbon footprint, comparing a carbon footprint, and transmitting remediation instructions. The instructions may be stored in a non-transitory storage medium.

Utilization data correspond to utilization of the internal components of a computing device. For example, a CPU, memory, disk, graphics processing unit (GPU), battery, fan, motherboard, integrated display, integrated keyboard lighting, network adapters, and additional subcomponents to support operation of the computing device. Likewise, utilization data may also include data from connected peripherals including but not limited to external monitors, docking stations, headsets, speakers, external cameras, standing desks, keyboards, and mice. In an office environment, connected office equipment may be incorporated into the utilization data including but not limited to networking routers, networking access points, proxy servers, printers, wall displays, shared monitors, shared docking stations, conference room equipment (e.g. A/V equipment), and retail points of sale.

A plurality of computing devices 106 may be communicatively connected to the processor 102. The plurality of computing devices 106 may be communicatively connected to the processor 102 by a network (not shown). The network may include but isn't limited to a local area network, wide area network, a virtual private network and the internet. The plurality of computing devices 106 may include a wide variety of devices. For example, programmable office equipment may be included in the plurality of computing devices 106. The plurality of computing devices 106 may include devices with the capability of monitoring themselves. The monitoring may be sensor and data collection and aggregation. In another example, the plurality of computing devices 106 may have a network connected reporting mechanism. The plurality of computing devices 106 may operate with a telemetry agent that collects sensor data and transmits that data to the processor 102. Additionally, the telemetry agent may be able to receive remediation instructions which may change the behavior of a single device within the plurality of the computing devices 106.

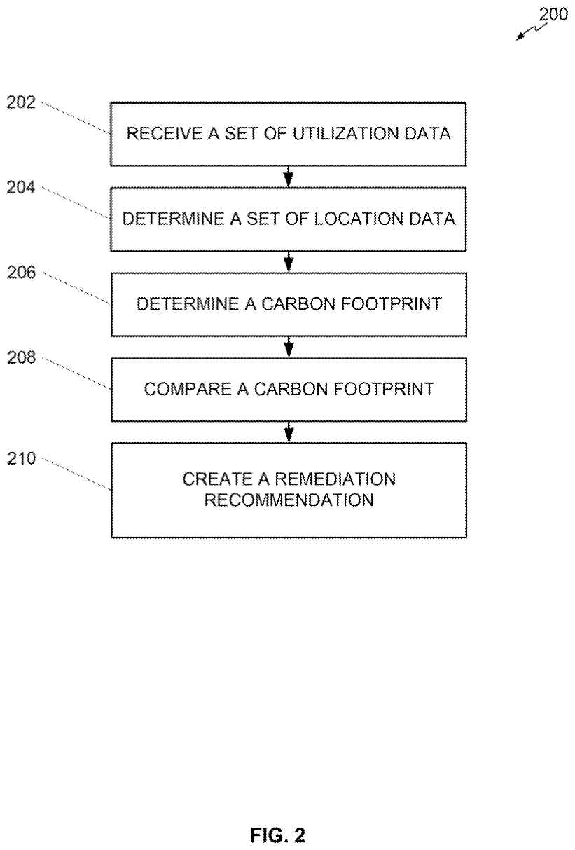

FIG. 2 is a block diagram 200 corresponding to a method of determining a carbon footprint remediation, according to an example. The method may be implemented utilizing the processor 102 of FIG. 1.

At 202, the processor 102 receives a set of utilization data. The utilization data may include telemetry data extracted by a telemetry agent operating on a computing device. The telemetry agent may be a software-based application executing with an operating system environment. In another implementation, the telemetry agent may include a firmware-based agent, wherein the telemetry may be collected during interrupts, transparent to the operating system. In another implementation the telemetry agent may independent hardware including an integrated circuit including logic and sensors to monitor the status of a computing device, without impacting the performance of the computing device. In each of the aforementioned implementations, the telemetry agent collects utilization data of the computing device. The telemetry agent collects utilization data described in reference to FIG. 1 for computer internals, connected peripherals and connected network devices.

In another implementation utilization data may correspond to computing device energy bands including expected startup, shutdown, and sleep power consumption levels on a per component in each state. Additionally, the utilization data may include calculating minutes spread of average device usage on a per component basis. Utilizing the energy band utilization and the spread utilization, the processor may extrapolate an energy consumption value for the day. The energy consumption value for the day may be stored as a part of the set of utilization data.

In another implementation utilization data may correspond to peripheral utilization data. A reference usage in watts per minute may be extracted from the telemetry agent. The processor 102 may calculate the peripheral active time by determining the active time of the host computing device. A peripheral energy usage may be the peripheral active time multiplied by the watts per minute. The peripheral energy usage may be stored as part of the set of utilization data.

In another implementation utilization data may correspond to connected network devices. In this implementation, a reference usage in watts per minute may be extracted from the telemetry agent on the connected network device. A connected network energy usage may be the reference usage multiplied by twenty four hours (as network connected device is available all day). The network connected device energy usage may be stored as part of the set of utilization data

At 204, the processor 102 determines a set of location data. The location data may correspond to a physical location of the device from which telemetry from a computing device was collected. For example, a workstation providing utilization data may physical reside at an office. The processor 102 may determine location data for that workstation by interfacing with a global positioning system receiver. In another implementation the location data may be determined by an internet protocol (IP) address. Geolocating an IP address may be utilized to determine a location data for a public IP address. In a network address translation (NAT) environment, where an IP is assigned internal to a non-public network, may utilize a landmarking system. Landmarks may correspond to certain subnets corresponding to different physical locations. Additionally, the location data may include location information based on proximity to other devices in proximity to each other. For example, a computing device location data may be determined based on IP address geolocation. A connected peripheral to the computing device, may have a location to be determined as the same location based on the physical relationship to the computing device. In another implementation, location data may be programmatically or manually stored in the computing device upon installation and accessed through an application programming interface (API). The set of location data may include location data from more than one computing device in proximity to each other. For example, a set of location data with common location data may correspond to a set of computing devices within a common worksite.

At 206, the processor 102 determines a carbon footprint. The carbon footprint may correspond to a carbon footprint of a specific worksite in one example. In another example, the carbon footprint may correspond to an organization with multiple worksites. The processor may apply a carbon emission rate to a subset of the set of utilization data. The carbon emission rate may correspond a site location within the set of location data. The carbon emission rate may correspond to a metric of carbon emissions from localized power generation. For example, carbon emission rate may be stored in tabular form (see Table 1) and be relatively static as production sources do not change frequently.

TABLE 1

| Country | Kg CO₂ per kWh |
|---|---|
| Sweden | 0.013 |
| France | 0.059 |
| Croatia | 0.21 |
| Luxembourg | 0.219 |
| Bulgaria | 0.47 |
| Poland | 0.773 |
| Estonia | 0.819 |

For example, worksite A may receive power generation from a low carbon emission rate source compared to worksite B. The processor 102 may aggregate the set of utilization data for corresponding to a common location. Upon aggregating, the utilization data for all devices at the common location, the processor 102 may apply the carbon emission rate to the aggregated utilization data. In one implementation, the applying the carbon emission rate may include a multiplicative operation.

In a multi-worksite, the previously describe process may be iterated across the entire set of location data, so that the entire set of utilization data may be correlated with a location, aggregated with like-location utilization, and a carbon emission rate applied to the aggregation. The organization carbon footprint may be an aggregation of the total carbon footprint aggregation for all worksites.

At 208, the processor 102 compares a carbon footprint. The processor 102 may compare location specific aggregate carbon footprints. As a resultant value may be in kg of CO₂ per year, a numeric comparison operator may be suited for the comparison. For example, worksite A may produce a total X kg of Caper year compared to worksite B which produces a total X-20 kg of CO₂ per year. In this example, worksite A may have a larger overall carbon footprint. In another example, worksite A hosts Y computing devices, peripherals and network connected devices, while worksite B hosts Y-400 computing devices, peripherals and network connected devices. In this example, worksite A has a lower per device carbon footprint. Likewise, different organizations may be compared for overall carbon footprints, site carbon footprints, and per device carbon footprints.

In another implementation, the processor 102 may compare the carbon footprint to a carbon footprint threshold. The carbon footprint threshold may correspond to an internal green energy goal of the organization. In another example, the threshold may correspond to governmental regulatory values. Likewise, the worksite or location specific carbon footprints may compare to a worksite or location specific carbon footprint threshold. In this latter example, the worksite or location specific carbon footprint threshold may be utilized to validate that a worksite is complaint with governmental regulatory values.

At 210, the processor 102 creates a remediation recommendation. Upon a comparison of a carbon footprint between two resultant carbon footprints, a recommendation may be made. If a site has a higher carbon footprint rate, a remediation system may recommend pushing a known system configuration to a fleet of devices. For example, if an organization receives a comparison between worksites, the larger carbon footprint worksite may receive a recommendation that notebook computers of a certain make and model be configured to run in low performance/energy saver mode. In another example, a recommendation to disable network connected devices in a low utilization area may be created. An endpoint management system may be utilized to push a configuration to a computing device, peripheral or network connected device.

Additionally, the recommendation may also include changing of hardware. Older computing devices, peripherals, and network connected devices may be identified with high utilization data (in watts per minute). Those devices may be recommended to be exchanged for more energy efficient models.

Another recommendation may include increasing shared devices, particularly when per computing device at a worksite per shared network connected device is a low value. Increasing the number of computing devices utilizing a network connected device may remediate a worksite carbon footprint.

In some implementations, the processor 102 may transmit remediation control instructions. The remediation control instructions may include the previously described performance configuration. An end point management system may be utilized to transmit the instructions for the remediation as well as other policy enforcement tools.

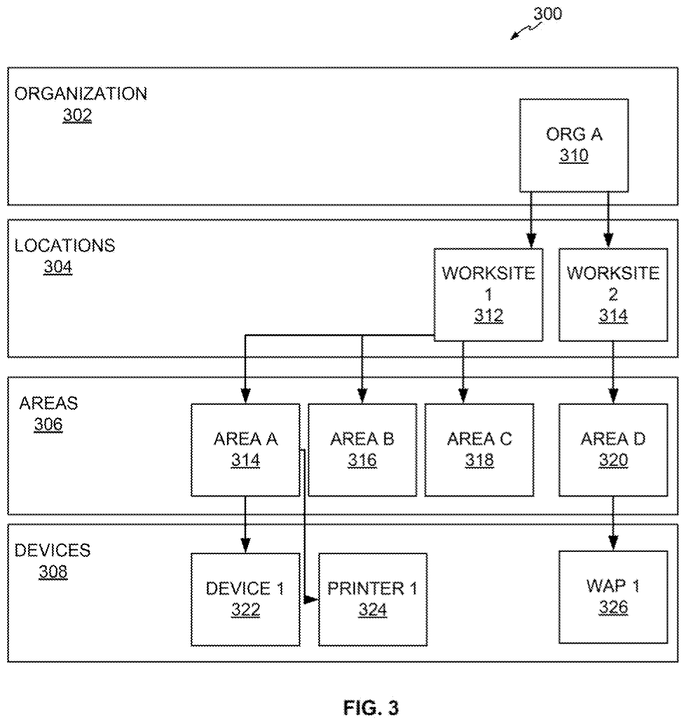

FIG. 3 is an illustration 300 of worksite relationships for carbon footprint remediation according to an example. As described in reference to FIG. 2, a set of locational data may be determined based on GPS data in the set of utilization data or IP address data in the set of utilization data.

The worksite relationship hierarchy may include at the top level an organization 302. In some implementations, the organization 302 may be omitted from the relationship, particularly, if the implementation may be only used internal to that organization. An organization in many instances may correspond to a company. An organization 302 may have a desire to evaluate the carbon footprint of corresponding worksites, to evaluate performance and remediate issues. An example organization A 310 is presented for visualization.

An organization 302 may include one or more locations 304. In the simplest example, an organization 302 may have one location. In more complex organizations, many more locations 304 may be present. Locations 304 may be geographically distinct, however, locations 304 may be selected by an implementer. In FIG. 3, worksite 1 312 and worksite 2 314 are illustrated as locations belonging to Organization A 310.

Within the locations 304 may exists areas 306. Areas 306 correspond to subdivisions of a location. Areas 306 may correspond to physical spaces, or in another implementation to a logical environment. A logical environment may correspond to a team orientated delineation. For example, multiple teams may co-occupy a physical space, however the Areas 306 may be determined to correspond to the teams in the space, not to the space itself. Illustrated in FIG. 3. area A 314, area B 316 and area C 318 correspond to worksite 1 312, and area D 320 corresponds to worksite 2 314.

Devices 308 correspond to the atomic unit of the relationship. Devices 308 may correspond to computing devices, peripherals, and network connect devices. Devices 308 may correspond to an area and constitute the source of the carbon footprint. FIG. 3 illustrates device 1 322 and printer 1 324 corresponding to area A 314. Likewise, wireless access point 1 (WAP), corresponds to area D 320.

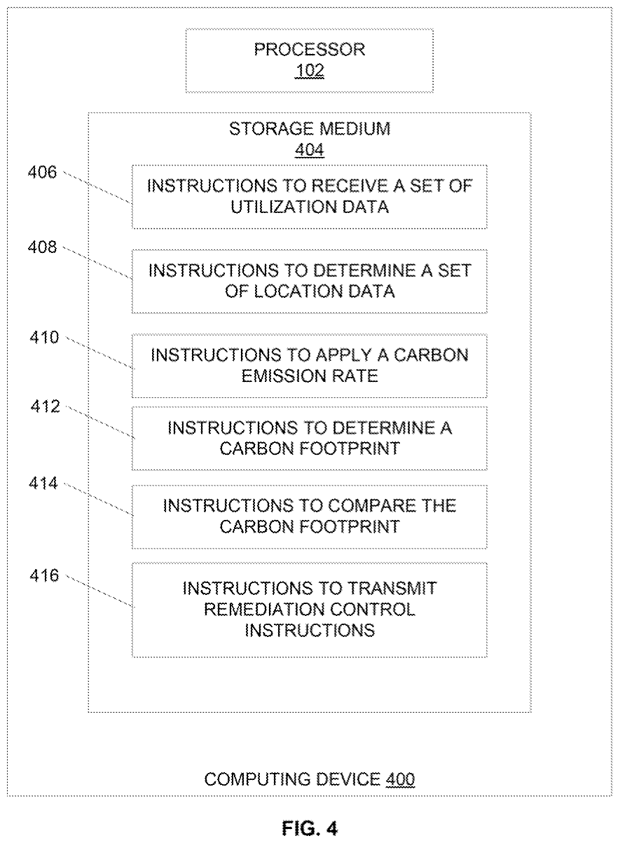

FIG. 4 is a computing device for supporting instructions for generating a carbon footprint remediation, according to an example. The computing device 400 depicts a processor 102 and a storage medium 404 and, as an example of the computing device 400 performing its operations, the storage medium 404 may include instructions 406-416 that are executable by the processor 102. The processor 102 may be synonymous with the processor 102 referenced in FIG. 1. Additionally, the processor 102 may include but is not limited to central processing units (CPUs). The storage medium 404 can be said to store program instructions that, when executed by processor 102, implement the components of the computing device 400. The executable program instructions stored in the storage medium 404 include, as an example, instructions to receive a set of utilization data 406, instruction to determine a set of location data 408, instruction to apply a carbon emission rate 410, instructions to determine a carbon footprint 412, instructions to compare the carbon footprint 414, and instructions to transmit remediation control instructions 416.

Storage medium 404 represents generally any number of memory components capable of storing instructions that can be executed by processor 102. Storage medium 404 is non-transitory in the sense that it does not encompass a transitory signal but instead is made up of at least one memory component configured to store the relevant instructions. As a result, the storage medium 404 may be a non-transitory computer-readable storage medium. Storage medium 404 may be implemented in a single device or distributed across devices. Likewise, processor 102 represents any number of processors capable of executing instructions stored by storage medium 404. Processor 102 may be integrated in a single device or distributed across devices. Further, storage medium 404 may be fully or partially integrated in the same device as processor 102, or it may be separate but accessible to that computing device 400 and the processor 102.

In one example, the program instructions 406-416 may be part of an installation package that, when installed, can be executed by processor 102 to implement the components of the computing device 400. In this case, storage medium 404 may be a portable medium such as a CD, DVD, or flash drive, or a memory maintained by a server from which the installation package can be downloaded and installed. In another example, the program instructions may be part of an application or applications already installed. Here, storage medium 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a plurality of computing devices;
a processor communicatively coupled to the plurality of computing devices, the processor to:
receive a set of utilization data from the plurality of computing devices;
determine a set of location data wherein each of location data in the set of location data corresponds to one of the set of utilization data of the plurality of computing devices;
determine a carbon footprint of the plurality of computing devices based on the set of utilization data and the set of location data;
compare the carbon footprint against a carbon footprint threshold; and
transmit remediation control instructions, based on the comparison, to the plurality of computing devices.

2. The system of claim 1 where in the carbon footprint threshold comprises jurisdictional guidelines for carbon emissions.

3. The system of claim 1 further comprising the processor to:
apply a carbon emission rate to a first subset of the set of utilization data, wherein the carbon emission rate corresponds to a first location in the set of location data.

4. The system of claim 1 wherein remediation control instruction comprises a software configuration to lower utilization of one of the plurality of computing devices.

5. The system of claim 1 wherein the plurality of computing devices comprises peripheral devices.

6. A method comprising:
receiving a set of utilization data from the plurality of computing devices;
determining a set of location data wherein each location data in the set of location data corresponds to one of the set of utilization data of the plurality of computing devices;
determining a carbon footprint of the plurality of computing devices based on the set of utilization data and the set of location data;
comparing the carbon footprint against a carbon footprint threshold;
creating a remediation recommendation, wherein the remediation recommendation corresponds to a utilization reduction per location in the set of location data.

7. The method of claim 6 further comprising:
applying a carbon emission rate to a first subset of the set of utilization data, wherein the carbon emission rate corresponds to a first location in the set of location data.

8. The method of claim 6 wherein each of the set of location data corresponds to an internet protocol address.

9. The method of claim 8 wherein at least one location data in the set of location data corresponds to a landmark position.

10. The method of claim 9 wherein the landmark position corresponds to a worksite.

11. A non-transitory computer readable medium comprising instructions executable by a processor to:
receive a set of utilization data from the plurality of computing devices;
determine a set of location data wherein each of location data in the set of location data corresponds to one of the set of utilization data of the plurality of computing devices;
apply a carbon emission rate to a first subset of the set of utilization data, wherein the carbon emission rate corresponds to a first location in the set of location data;
determine a carbon footprint of the first subset based at least in part on the carbon emission rate;
compare the carbon footprint against a carbon footprint threshold; and
transmit remediation control instructions to the plurality of computing devices.

12. The non-transitory computer readable medium of claim 11 further comprising:
identify a second subset from the set of utilization data that corresponds to network attached equipment;
compare the second subset to the first subset; and
transmit hibernation control instructions to the network attached equipment when the second subset is higher than the first subset.

13. The non-transitory computer readable medium of claim 12 wherein the network attached equipment comprises networked printers.

14. The non-transitory computer readable medium of claim 11 wherein the carbon footprint threshold comprises jurisdictional guidelines for carbon emissions.

15. The non-transitory computer readable medium of claim 11 wherein the set of utilization data corresponds to processing loads on computing devices.
